(19) United States
(12) Patent Application Publication
(10) Pub. No.: US 2026/0094368 A1
(43) Pub. Date: Apr. 2, 2026

(54) SYSTEMS AND METHODS FOR CONCAVE MESH COLLISION

(71) Applicant: Electronic Arts Inc., Redwood City, CA (US)

(72) Inventor: Lee CULLEN, Waterlooville (GB)

(73) Assignee: Electronic Arts Inc., Redwood City, CA (US)

(21) Appl. No.: 18/901,113

(22) Filed: Sep. 30, 2024

(51) Int. Cl. G06T 17/20

(52) U.S. Cl. CPC G06T 17/20; G06T 2210/21

(57) ABSTRACT

A first set of contact points for a hull object colliding with a first primitive of a mesh object is determined. An edge clip is generated for an edge of the first primitive based on determining that the hull object generates contact points with the edge. A face walk is performed into a second primitive of the mesh object across the edge for the edge clip. A set of initial contact points for the hull object colliding with the second primitive is generated using the algorithm. A second set of contact points is generated based on projecting each initial contact point in a direction of a contact normal for the first set of contact points onto a plane created by extending a feature of the first primitive. Contact points in the first and second set of contact points are output, but not the contacts along the edge clip.

### FIELD

This disclosure generally relates to computer graphics and, more particularly, to system and methods for contact generation between graphical objects in flat and concave regions of a mesh.

### BACKGROUND

In computer-generated graphics applications, such as video games or animated films, characters in the graphics application typically comprise 3D (three-dimensional) character models. In the context of video games, an in-game character model may include hundreds of adjustable parameters. The parameters can be modified to give the in-game character a distinct appearance. The in-game character model may interact with the environment in different ways such as by jumping off ledges, bouncing off walls, or crashing through other objects.

Computer-generated graphics applications often determine contact points or execute contact generation between two objects to prevent clipping between the objects as they intersect or otherwise interact with each other. Performing contact generation improperly introduces visual artifacts that destroy the immersion of the player as an avatar or in-game character model interacts with their surrounding environment.

As used herein, “clipping” refers to two or more objects intersecting improperly. An example of clipping is when a first object goes through another object in an unrealistic way, such as by clipping a foot of an in-game character through a floor of an environment where in the real world someone’s foot would stand in contact with the floor and not penetrate the floor. Various problems can occur when attempting to execute contact generation for objects and, in particular, when treating a mesh object with concave or flat edges as a collection of individual primitives constructed from the polygonal faces of the mesh during contact generation. For example, when a convex hull approaches an edge of a mesh, unlike in a convex case, regions connected by flat or concave joins can have different times of impact (TOI) for each region. In scenarios where an object may collide with a mesh that represents a floor meeting a wall, depending on the speed of the object, the object may intersect with both the floor and the wall requiring contact points to be generated for the floor and the wall. It should be noted that after a first impact the motion of the two objects may not follow a predicted trajectory. Contact points may need to be generated to prevent secondary collisions. However, this is difficult as TOI is generated, as well as a point of closest approach and best separating direction, without knowledge of the initial impact.

One issue with contact generation arises when a system treats each primitive of a mesh object separately for determining collision with another object, for example, a hull object such as a convex hull resting on a flat mesh. A primitive, as used herein, refers to a polygonal cell comprised of vertices, edges, and a face, which is the building block of a mesh. In this scenario, contact points are generated for each corner of the bottom face of the convex hull, each edge of the mesh where the convex hull crosses the mesh, and at mesh vertices that are within the bounds of a bottom face of the convex hull. This produces many redundant contacts that do not help prevent clipping and also cost computing time to generate and solve. Properly determining contact points between objects only gets more complicated when considering an object being rotated during collision, feature clipping due to non-flat surfaces, or sliding cases where an object may slide along a non-flat surface.

### SUMMARY

Embodiments of the disclosure provide a method, computer-readable storage medium, and device for determining contact points for collision between a convex hull and a mesh. The method includes: generating a first set of contact points for a hull object colliding with a first primitive of a mesh object using a feature intersection algorithm, wherein a contact normal for the contact points is a direction along which contact points on the hull object and the mesh object are constrained by in order to resolve a collision between the hull object and the mesh object; determining a set of edge contact points for the hull object colliding with the first primitive of the mesh object using the feature intersection algorithm, wherein the set of edge contact points includes contact points along an edge of the first primitive, wherein the edge is a concave edge or a flat edge of the mesh object; generating an edge clip for the edge; determining, for the edge clip, to face walk into a second primitive of the mesh object across the edge; generating a set of initial contact points for the hull object colliding with the second primitive of the mesh object using the feature intersection algorithm; generating a second set of contact points based on projecting each initial contact point in the set of initial contact points in a direction of the contact normal for the contact points in the first set of contact points onto a plane created by extending the feature of the first primitive on which the contact points in the first set of contact points are located; and outputting contact points in the first set of contact points and the second set of contact points as output contact points for the hull object colliding with the mesh object, wherein the output contact points for the hull object colliding with the mesh object do not include the set of edge contact points.

### BRIEF DESCRIPTION OF THE DRAWINGS

FIG. 1 is a block diagram of a computer system for rendering images, according to aspects of the present disclosure.

FIG. 2 is a block diagram illustrating processor and buffer interaction, according to an embodiment.

FIG. 3 is a conceptual diagram illustrating a hull object colliding with a mesh object and determining contact points between the hull object and the mesh object, according to an embodiment.

FIG. 4 is a conceptual diagram illustrating a hull object colliding with a mesh object and determining contact points between the hull object and the mesh object, according to an embodiment.

FIG. 5 is a conceptual diagram illustrating a hull object colliding with a mesh object and determining contact points between the hull object and the mesh object, according to an embodiment.

FIG. 6 is a conceptual diagram illustrating a hull object colliding with a mesh object with concave edges and determining contact points between the hull object and the mesh object, according to an embodiment.

FIG. 7 is a conceptual diagram illustrating a hull object colliding with a mesh object and determining contact points between the hull object and the mesh object, where the mesh feature is an edge, according to an embodiment.

FIG. 8 is a conceptual diagram illustrating generating edge clips during feature intersection for edge and face features of a convex hull against a face feature of a mesh by projecting the features onto a common plane defined by the contact normal, according to an embodiment.

FIG. 9 illustrates conceptual diagrams of generating an edge clip in a scenario where a mesh vertex connected to an edge also intersects with a convex hull face, according to some embodiments.

FIG. 10 is a flow diagram of method steps for determining contact points for a convex hull colliding with a mesh, according to an embodiment.

### DETAILED DESCRIPTION

The following detailed description provides examples that are not intended to limit the disclosure or the application and uses of the disclosure. Furthermore, there is no intention to be bound by any expressed or implied theory presented in the preceding technical field, background, summary, brief description of the drawings, or the following detailed description.

As described in greater detail herein, embodiments of the disclosure provide a system and method for determining contact points for colliding a convex hull object with a mesh using generated edge clips. In some embodiments, input is provided to a feature intersection algorithm that a joining edge of a mesh is flat or concave and instead of creating a contact point at the edge, the system generates an “edge clip.” The edge clip may store where the features of a hull object and mesh object intersect or clip against each other, and an identifier (ID) of the edge in the mesh object where it has clipped against the hull object. In some embodiments, the edge clips may be stored in such a manner that to identify from which mesh face they originated. The feature intersection algorithm may include an algorithm or system to compute intersections or closest points between features (such a vertex, edge or face) of two objects by projecting the features of each object onto a common plane defined by the contact normal.

The present disclosure provides a system that solves contact generation issues of meshes in flat and concave regions by considering how the surrounding primitives of the meshes are connected. In some embodiments, the system may consider surrounding primitives by face walking to extend contact points across mesh face boundaries. In an embodiment, the system may create edge clips rather than contact points at flat edges, with the edge clips storing the clipping points and edge IDs. The edge clips and face walking are then used to find neighboring mesh primitives that are used to generate contact points with the same hull object. This implementation can be also applied to concave edges by using an infinite plane of a source mesh primitive to generate contact points with a neighboring primitive of a mesh object. The contact points are then projected onto the same plane as the feature used by the source mesh primitive, which prevents a hull object from penetrating the source mesh primitive.

Taking the context of video games as an example, the display of a video game is generally a video sequence presented to a display capable of displaying the video sequence. The video sequence typically comprises a plurality of frames. By showing frames in succession in sequence order, simulated objects appear to move. A game engine typically generates frames in real-time response to user input, so rendering time is often constrained.

As used herein, a “frame” refers to an image of the video sequence. In some systems, such as interleaved displays, the frame might comprise multiple fields or more complex constructs, but generally a frame can be thought of as a view into a computer-generated scene at a particular time or short time window. For example, with 60 frames-per-second video, if one frame represents the scene at t=0 seconds, then the next frame would represent the scene at t= 1/60 seconds or 16 ms. In some cases, a frame might represent the scene from t=0 seconds to t= 1/60 seconds, but in the simple case, the frame is a snapshot in time.

A “scene” comprises those simulated objects that are positioned in a world coordinate space within a view pyramid, view rectangular prism or other shaped view space. In some approaches, the scene comprises all objects (that are not obscured by other objects) within a view pyramid defined by a view point and a view rectangle with boundaries being the perspective planes through the view point and each edge of the view rectangle, possibly truncated by a background.

The simulated objects can be generated entirely from mathematical models describing the shape of the objects (such as arms and a torso described by a set of plane and/or curve surfaces), generated from stored images (such as the face of a famous person), or a combination thereof. If a game engine (or more specifically, a rendering engine that is part of the game engine or used by the game engine) has data as to where each object or portion of an object is in a scene, the frame for that scene can be rendered using standard rendering techniques.

A scene may comprise several objects or entities with some of the objects or entities being animated, in that the objects or entities may appear to move either in response to game engine rules or user input. For example, in a basketball game, a character for one of the basketball players might shoot a basket in response to user input, while a defending player will attempt to block the shooter in response to logic that is part of the game rules (e.g., an artificial intelligence component of the game rules might include a rule that defenders block shots when a shot attempt is detected) and when the ball moves through the net, the net will move in response to the ball. The net is expected to be inanimate, but the players’ movements are expected to be animated and natural-appearing. Animated objects are typically referred to herein generically as characters and, in specific examples, such as animation of a football, soccer, baseball, basketball, or other sports game, the characters are typically simulated players in the game. In many cases, the characters correspond to actual sports figures and those actual sports figures might have contributed motion capture data for use in animating their corresponding character. Players and characters might be nonhuman, simulated robots, or other character types.

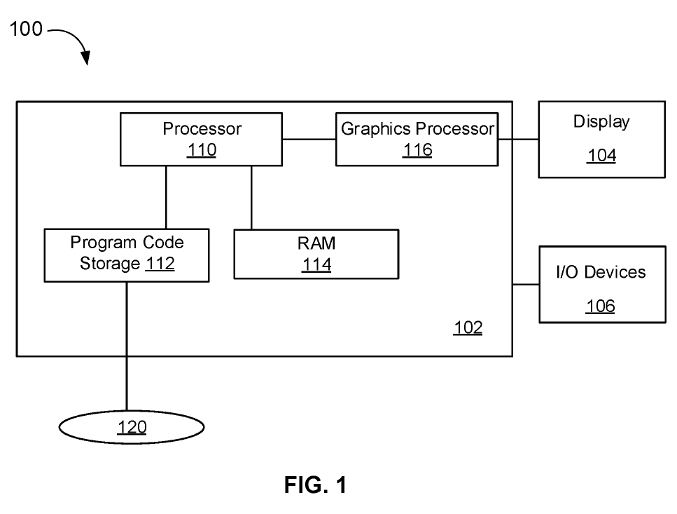

Turning to the drawings, FIG. 1 is a block diagram of a computer system 100 for rendering images, according to aspects of the present disclosure. The computer system 100 may be, for example, used for rendering images of a video game. The computer system 100 is shown comprising a console 102 coupled to a display 104 and input/output (I/O) devices 106. Console 102 is shown comprising a processor 110, program code storage 112, temporary data storage 114, and a graphics processor 116. Console 102 may be a handheld video game device, a video game console (e.g., special purpose computing device) for operating video games, a general-purpose laptop or desktop computer, or other suitable computing system, such as a mobile phone or tablet computer. Although shown as one processor in FIG. 1, processor 110 may include one or more processors having one or more processing cores. Similarly, although shown as one processor in FIG. 1, graphics processor 116 may include one or more processors having one or more processing cores.

Program code storage 112 may be ROM (read only-memory), RAM (random access memory), DRAM (dynamic random access memory), SRAM (static random access memory), hard disk, other magnetic storage, optical storage, other storage or a combination or variation of these storage device types. In some embodiments, a portion of the program code is stored in ROM that is programmable (e.g., ROM, PROM (programmable read-only memory), EPROM (erasable programmable read-only memory), EEPROM (electrically erasable programmable read-only memory), etc.) and a portion of the program code is stored on removable media such as a disc 120 (e.g., CD-ROM, DVD-ROM, etc.), or may be stored on a cartridge, memory chip, or the like, or obtained over a network or other electronic channel as needed. In some implementations, program code can be found embodied in a non-transitory computer-readable storage medium.

Temporary data storage 114 is usable to store variables and other game and processor data. In some embodiments, temporary data storage 114 is RAM and stores data that is generated during play of a video game, and portions thereof may also be reserved for frame buffers, depth buffers, polygon lists, texture storage, and/or other data needed or usable for rendering images as part of a video game presentation.

In one embodiment, I/O devices 106 are devices a user interacts with to play a video game or otherwise interact with console 102. I/O devices 106 may include any device for interacting with console 102, including but not limited to a video game controller, joystick, keyboard, mouse, keypad, VR (virtual reality) headset or device, etc.

Display 104 can any type of display device, including a television, computer monitor, laptop screen, mobile device screen, tablet screen, etc. In some embodiments, I/O devices 106 and display 104 comprise a common device, e.g., a touchscreen device. Still further, in some embodiments, one or more of the I/O devices 106 and display 104 is integrated in the console 102.

In various embodiments, since a video game is likely to be such that the particular image sequence presented on the display 104 depends on results of game instruction processing, and those game instructions likely depend, in turn, on user inputs, the console 102 (and the processor 110 and graphics processor 116) are configured to quickly process inputs and render a responsive image sequence in real-time or near real-time.

Various other components may be included in console 102, but are omitted for clarity. An example includes a networking device configured to connect the console 102 to a network, such as the Internet.

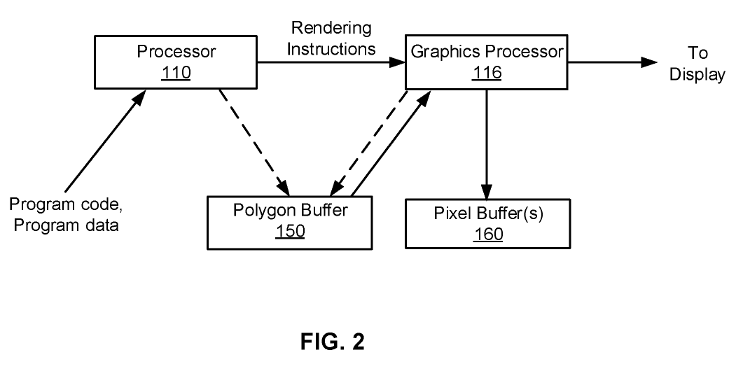

FIG. 2 is a block diagram illustrating processor and buffer interaction, according to one embodiment. As shown in FIG. 2, processor 110 executes program code and program data. In response to executing the program code, processor 110 outputs rendering instructions to graphics processor 116. Graphics processor 116, in turn, reads data from a polygon buffer 150 and interacts with pixel buffer(s) 160 to form an image sequence of one or more images that are output to a display. Alternatively, instead of sending rendering instructions to graphics processor 116 or in addition to sending rendering instructions to graphics processor 116, processor 110 may directly interact with polygon buffer 150. For example, processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. In some implementations, such high-level graphics commands might be those specified by the OpenGL specification, or those specified by a graphics processor manufacturer.

In one implementation of an image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. As such, a renderer processes a stream of polygons, even though the polygons may be read in place and be a finite set, where the number of polygons is known or determinable. For memory efficiency and speed, it may be preferable in some implementations that polygons be processed as a stream (as opposed to random access, or other ordering), so that fast, expensive memory used for polygons being processed is not required for all polygons comprising an image.

In some embodiments, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

In computer-generated visual content (such as interactive video games), objects may be represented by various computer-generated models, including polygonal meshes and texture maps. A polygonal mesh herein shall refer to a collection of vertices, edges, and faces that define the shape and/or boundaries of a three-dimensional object. A texture map herein shall refer to a projection of an image onto a corresponding polygonal mesh.

Texture mapping provides a method to map colors and other information to pixels from one or more 2D textures to a 3D surface of an object, analogous to “wrapping” a 2D image around the 3D object. In the advent of multi-pass rendering, texture mapping can also include more complex mappings, such as height mapping, bump mapping, normal mapping, displacement mapping, reflection mapping, specular mapping, occlusion mapping, and the like. These techniques make it possible to create near-photorealistic renderings of 3D objects.

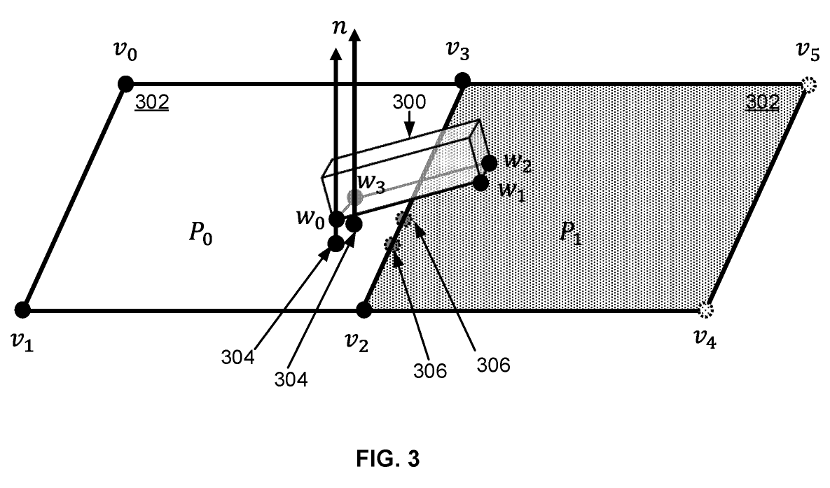

FIGS. 3-5 depict conceptual diagrams illustrating a hull object colliding with a mesh object and determining contact points between the hull object and the mesh object, according to an embodiment. As described herein, problems exist with feature clipping, where objects may end up clipping face features of the convex hull against flat or concave edges of a mesh object, resulting in a set of contacts between these two objects that can still allow for penetration or incorrect collision. Conventional solutions may attempt to resolve this by generating an excessive number of contact points between internal edges of flat faces of the mesh object. This is a consequence of treating each primitive separately rather than a deliberate attempt to make more contacts. Some solutions treat each primitive in a mesh object separately, so contacts are generated at every point, where once projected onto a common plane defined by the contact normal, an edge of a convex hull intersects with an edge of a mesh object, or where a vertex of a mesh object is fully inside a face of a hull object.

In one example, a convex hull sits on a flat mesh object, where the convex hull straddles two mesh faces. If the two resulting mesh faces are treated separately, one could find the best separating direction and TOI for each face. To generate contacts, a system can run two passes of a feature intersection algorithm with each mesh face. By doing this, each mesh face generates its own contact points with the hull object. Systems that use a contact solver may implement infinite planes to solve the generated contact constraints in this scenario. Since the mesh is flat, the normal of all the contacts for both mesh faces are the same, and the contact solver may see several contacts all against the same infinite plane. However, in cases where the convex hull is flat or close to flat on the mesh, typically the best separating direction (BST) with each mesh primitive will be the normal of the mesh faces. This results in excessive contact point generation. In cases where the convex hull represents a box that is rotated and colliding with the mesh, the best separating direction with one of the primitives of the mesh will be normal to the flat edge, but not normal to the face. This results in the mesh primitive being rejected for contact generation thereby not generating all the contacts required to prevent penetration by the box of the mesh. Rejection occurs to prevent edge contacts that will snag the horizontal movement of the box.

In accordance with at least one embodiment, the systems and methods of the present disclosure can provide input to the feature intersection algorithm that a joining edge is flat, and instead of creating a contact point at the edge, the present disclosure generates an edge clip. The edge clip stores where the features clip against each other as well as the ID of the edge in the mesh the object clipped against. The system may loop over the edges the object clipped against to find the neighboring mesh primitives (e.g., faces). The system may then run the feature intersection algorithm again using the same feature from the convex hull but using the feature of the neighboring mesh primitive . The neighboring primitive may be processed again and instead of creating contact points on the flat edge, an edge clip may be created. This prevents the system from generating contacts along an internal edge between two faces of a mesh object and ensures that the contact points are placed at appropriate points on the convex hull object to prevent penetration thereby resolving the problems discussed above (e.g. excessive contact point generation and inappropriate contact point placement that still allows penetration).

FIGS. 3-5 depict an example of generating contact points for a collision between hull object 300 and mesh object 302 with primitives P₀ and P₁. The features of the present disclosure may generate contact points 304 between hull object 300 and mesh object 302 using a face feature of primitive P₀. The system may consider the face feature of primitive P₀ as the set of vertices {v₀, v₁, v₂, v₃} and hull face as the set of vertices {w₀, w₁, w₂, w₃}. The system may generate the contact points 304 and an edge clip for the edge {v₂, v₃} and store the contact points that were clipped and generated (depicted at 306). In some embodiments, the system may process the edge {v₂, v₃} of the edge clip and find that primitive P₁ is the mesh primitive on the opposite side of the edge {v₂, v₃}. Primitive P₀ can also then be marked are processed, so that in further iterations of the process for other primitives the primitive P₀ can be skipped as already processed.

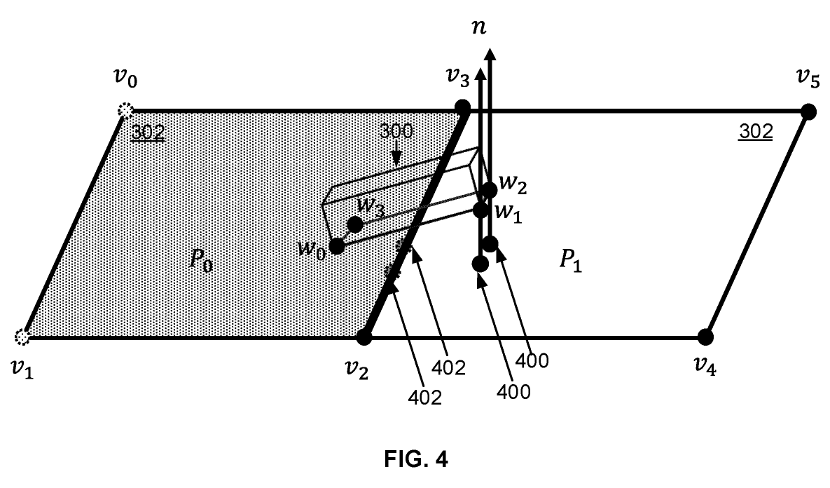

FIG. 4 depicts the generation of contact points between the hull object 300 and primitive P₁ using the mesh face {v₄, v₅, v₃, v₂} and hull face {w₀, w₁, w₂, w₃}. The system creates two contact points 400 and then generates an edge clip consisting of the edge {v₃, v₂} and stores the points that were clipped (depicted at 402). The system then processes the edge clip from primitive P₁ and determines that primitive P₀ has already been processed and no further action is necessary.

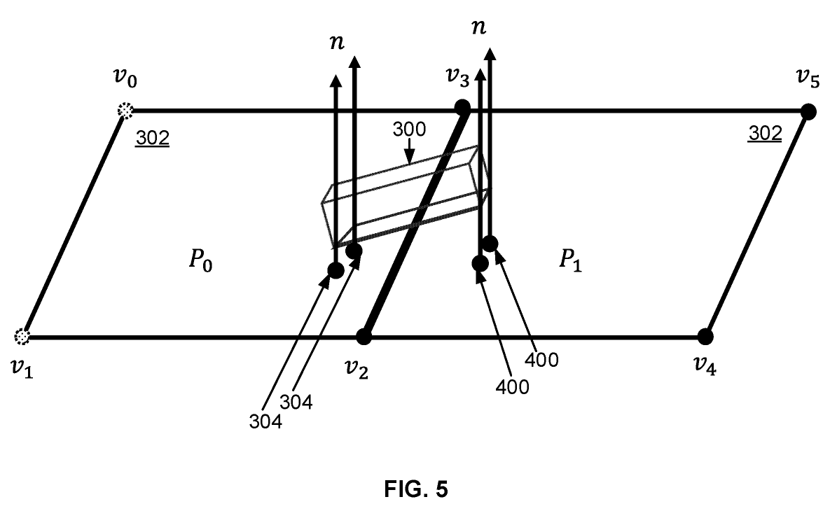

FIG. 5 depicts the final result where the two contacts 304 and the two contacts 400 are generated for hull object 300. For flat face mesh objects, such as 302 of FIGS. 3-5, the system provides improvements over conventional systems by no longer needing to generate contact points on internal edges/vertices, guaranteeing to generate all the contact points required to prevent the hull object 300 from penetrating the contact plane, and is faster as the system does not need to reload convex hull data. The process described above with reference to FIGS. 3-5 of creating edge clips and then processing neighboring faces is referred to herein as “face walking.”

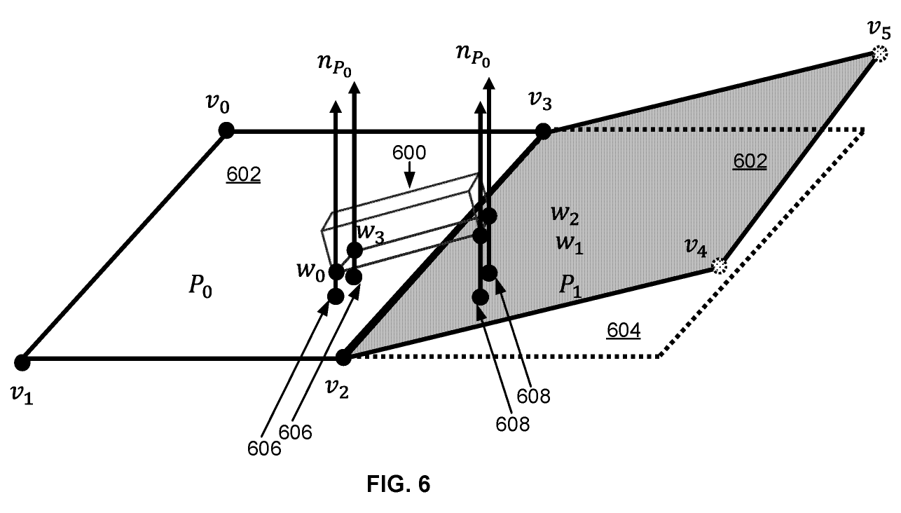

FIG. 6 is a conceptual diagram illustrating a hull object 600 colliding with a mesh object 602 with concave edges and determining contact points between the hull object 600 and the mesh object 602, according to an embodiment. FIG. 6 depicts the application of face walking to concave edges. In order to resolve collisions, contact constraints may include a point on each object and an infinite plane that separates the two points on each object. At a concave join between two faces, the infinite plane of both faces connects through the shared edge to extend underneath the opposite face. This is depicted in FIG. 6 as infinite plane of P₀ extends under P₁. This can be used by the system to ensure that it is safe to generate contact points with the extended plane 604 as it will never prevent any valid motion of the hull object 600.

In particular, FIG. 6 depicts the contact points 606 generated using the face feature of primitive P₀ of the mesh object 602 against the bottom face of the hull object 600. An edge clip is generated for edge {v₂ , v₃}. In some embodiments, the system may face walk edge {v₂, v₃} and then move into the primitive on the opposite side of the edge, i.e., primitive P₁. The face feature and vertices of primitive P₁ along with the normal of primitive P₀ (nₚ₀) are used to generate contact points on the surface of primitive P₁. These contact points on the surface of primitive P₁ are then projected on to the same plane as the original feature, i.e., the face of P₀, along the contact normal nₚ₀ to generate contact points 608 on the plane of the face of P₀. By generating the contact points 606 and 608 in this manner, the hull object 600 is prevented from penetrating P₀, even if the hull object 600 moves further towards P₀ or rotates.

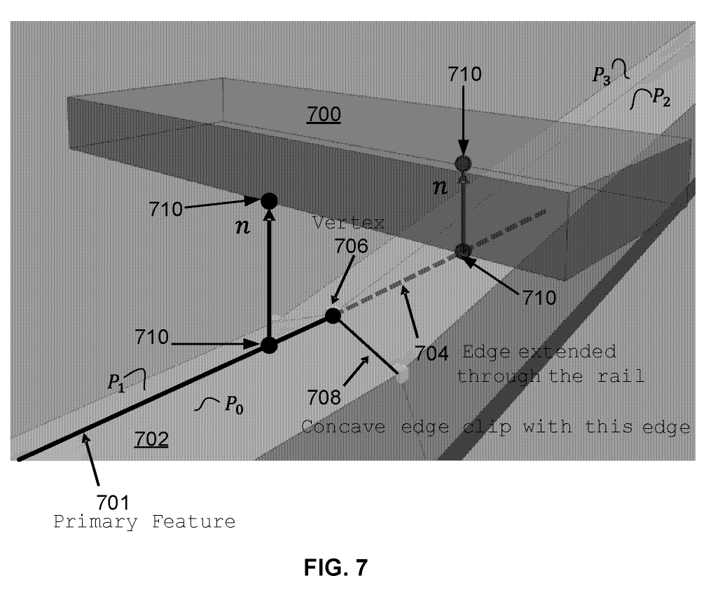

FIG. 7 is a conceptual diagram illustrating a hull object 700 colliding with a mesh object 702 and determining contact points between the hull object 700 and the mesh object 702, where the mesh feature is an edge, according to an embodiment. Mesh object includes primitives P_{0,} P_{1,} P₂, and P₃. Certain scenarios may occur where a mesh feature of collision of the hull object 700 and the mesh object 702 could be an edge of the mesh object 702 that is connected to one or more flat or concave edges. The example depicted in FIG. 7 includes a convex hull object 700 is above a rail (mesh object 702), where the top edge of the rail joins at a concave angle. The mesh feature for the collision for primitive P₀ is the same mesh feature for the collision for primitive P₁ (i.e., the edge between primitive P₀ and primitive P₁). Primitives P₀ and P₁ may comprise the convex edge 701 on the top of the rail (mesh object 702). FIG. 7 also depicts the extension 704 of the convex edge 701 depicted as the primary feature in FIG. 7. The system may use the convex edge 701 of the mesh against the bottom face of the convex hull 700 to generate contacts.

A conventional system may create a contact point at the vertex 706 at the end of the edge between the faces of primitive P₀ and primitive P₁. This would produce a contact point roughly in the center of the bottom face of the convex hull 700. However, if the hull object 700 were to slide towards the edge 701 (primary feature) during a time step, it would be possible for the bottom face of the hull object 700 to penetrate the top edge of the mesh 702. Instead, the system of the present disclosure uses face walking to generate contact points that prevent penetration with the edge 701 or primary feature. During this face walking, since the other edge of the vertex 706 is concave, the vertex 706 may be flagged and then passed on to the feature intersection algorithm. Instead of creating a contact, some embodiments can add an edge clip using the non-convex edge 708 as depicted in FIG. 7 (e.g., edge 708). The system may then identify a primitive on the opposite side of the edge 708 and use the feature associated with that mesh primitive (P 2) in order to create contact points 710 on the extended edge 704.

Some embodiments of the present disclosure may further utilize contact filtering. As the system face walks, a primary and a promoted feature of a mesh primitive the system has stepped into may not be the same. A primary feature, as used herein, includes the feature (vertex, edge, or face) that is most perpendicular of the best separating direction. In the case of a tie, some embodiments choose the higher order feature. For example, the order of preference for the system may be first face, then edge, then vertex. A promoted feature, as used herein, includes a higher order feature that is considered close enough to perpendicular to the best separating direction (BSD) (for example, within a threshold) such that we want to use it to generate contacts. In the case of a tie, the system may choose the higher order feature. For example, in FIG. 7 the angle of the faces that formed the rail object of the mesh object 702 could be such that the faces on either side of the convex edge are approaching co-linear. In such scenarios it is likely that the primary feature is the convex edge and the promoted feature is the face. This would happen to prevent small rotations of the hull 700 penetrating the faces of the rail 700. This can be resolved when generating contacts with P 0 by adjusting the contact normal for contacts generated on the edge to use the primary normal (edge normal) rather than the promoted (face) normal. The system does this when face walking thereby ensuring that contacts generated on the extended edge 704 will use the primary feature normal.

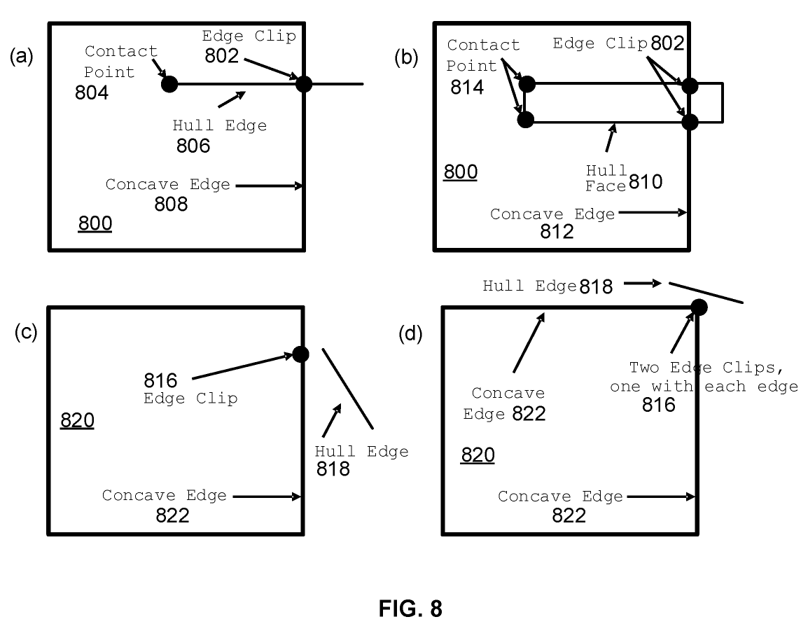

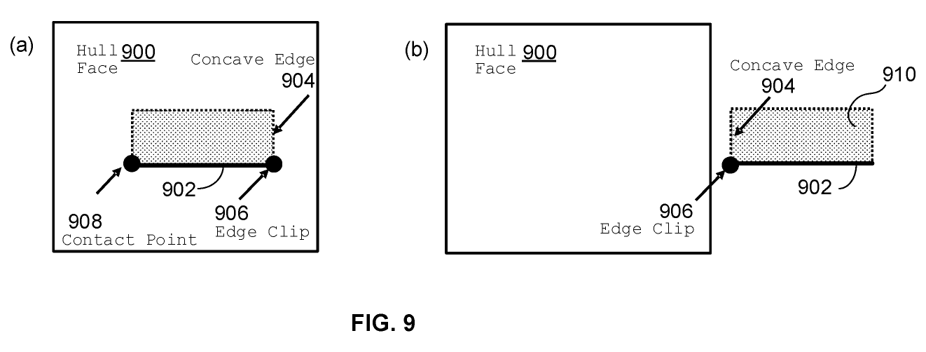

FIG. 8 is a conceptual diagram illustrating generating edge clips during feature intersection for edge and face features of a convex hull against a face feature of a mesh by projecting the features onto a common plane defined by the contact normal, according to an embodiment. In some embodiments, face walking may include, when obtaining mesh primitive vertices, the promoted feature of the mesh being a face and obtaining the list of concave and flat edges in the face, or the promoted feature being an edge and determining if the two adjacent edges (one connected to each vertex) are concave or flat. The system may also, when executing the feature intersection algorithm (depicted in FIGS. 8 and 9), create an edge clip instead of a contact point in scenarios where a mesh face intersects with a hull face or edge and if an edge of the hull intersects a flat or concave edge of the mesh. When executing the feature intersection algorithm, the system may also create an edge clip instead of creating contact points in scenarios where the convex hull feature is within a region, such as a Voronoi region, of a concave edge and outside the bounds of the mesh face. A Voronoi region may include a region in which a number of points scattered on a plane divides the plane into regions of exactly n cells such that the points of each cell are closest to a seed point. When executing the feature intersection algorithm the system may also create an edge clip instead of creating a contact point in scenarios where the mesh edge intersects with a hull face if a vertex on the edge is inside the hull face and the edge vertex has a flat or concave adjacent edge. When executing the feature intersection algorithm, the system may also create an edge clip instead of creating a contact point in scenarios where the mesh edge is fully outside a hull face and a mesh vertex adjacent to a flat or concave edge is the nearest feature.

The face walking algorithm may include, for each edge clip, determining whether to face walk into a neighboring primitive of a mesh object. A positive determination to face walk into a neighboring primitive results in the neighboring primitive being added to a list of primitives to visit. The face walking algorithm may use several conditions for determining to face walk into a neighboring primitive such as: if there is a mesh primitive on the other side of the edge (i.e. the edge is not open); there is a valid primitive pair that is considered colliding with the hull associated with the neighboring mesh primitive; if primitives with rejected features are accepted since the system only extends the contact points for a current normal, in such scenarios the algorithm may use the face as the feature or determine it some other way; if the primitive hasn’t already been visited from the start primitive and the system hasn’t already added the primitive to the list (this prevents circular walks); in scenarios where the face walking has to walk flat edges – check that the system hasn’t processed the potential primitive for contact generation already (this prevents creating duplicate contacts for flat faces); and if the primitive we are walking into forms an angle smaller than 90° with the original primitive as once the system goes past this limit the best separating direction is not useful and no partial overlap of the extended plane is allowed. The face walking algorithm also includes, for each item in the list of primitives to visit, extracting the mesh feature and performing contact generation with the hull feature.

FIG. 8 depicts several mesh faces 800 and the generation of edge clips 802 at edge intersections. For example, FIG. 8 depicts at (a) contact point 804 and edge clip 802 for a hull edge 806 intersecting with a concave edge 808 of the mesh face 800. FIG. 8 also depicts at (b) a scenario where the hull face 810 intersects with concave edge 812 of mesh face 800 as well as contact points 814 and edge clip 802. FIG. 8 also depicts at (c) a scenario for generating edge clip 816 for a situation where a convex hull edge 818 is outside the bounds of mesh face 820 and closest to the concave edge 822. The scenario depicted at (d) in FIG. 8 is for when the hull edge 818 is outside the bounds of the mesh face 820 and closest to a vertex connected to two concave edges 822 of the mesh faces 820 where two edge clips 816 are generated, one for each edge 822. It should be noted that the edges 808, 812, and 822 shown in FIG. 8 as concave can be concave or flat.

FIG. 9 depicts a top view of a convex hull face 900 colliding with a mesh edge 902, according to some embodiments. As shown in example (a) in FIG. 9, the mesh edge 902 includes a mesh vertex that is connected to concave edge 904. Using the face walking algorithm, edge clip 906 is created at the vertex. Example (a) in FIG. 9 also includes contact point 908 for the mesh edge 902 intersecting within the bounds of the hull face 900. In example (b) in FIG. 9, edge clip 906 is created at the closest mesh vertex of mesh face 910 when the hull face is 900 is outside the bounds of the mesh face 910 and connected to a flat or concave edge (e.g., edge 904).

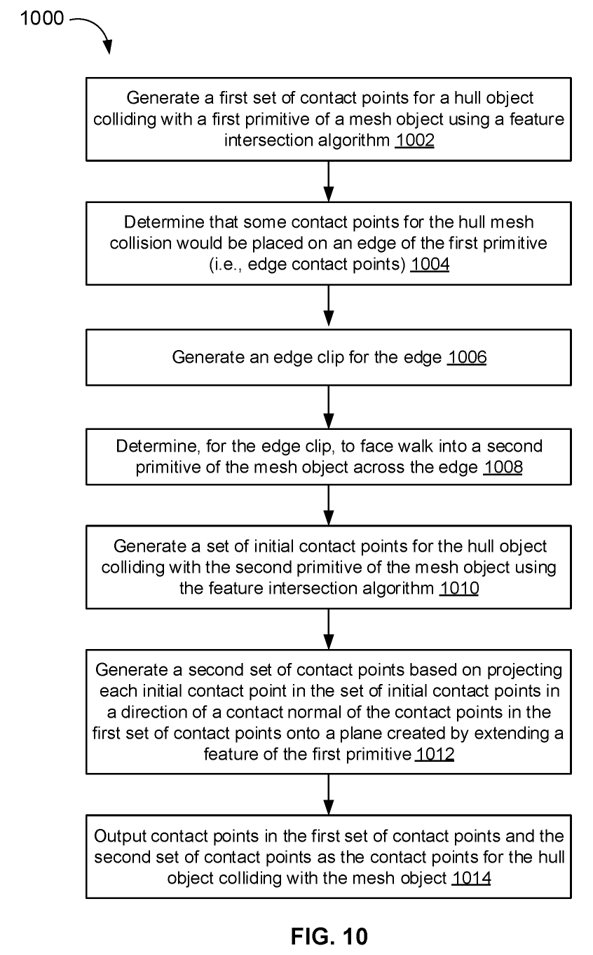

FIG. 10 is a flow diagram of method steps for determining contact points for collision between a convex hull and a mesh, according to an embodiment. In various implementations, the method can be performed by the processor 110, the graphics processor 116, or a combination of the processor 110 and the graphics processor 116.

The method begins at step 1002, where a processor generates a first set of contact points for a hull object colliding with a first primitive of a mesh object using a feature intersection algorithm. A contact point normal for the contact points in the first set of contact points is a direction along which the contact points on two objects (e.g., the hull object and the mesh object) are constrained by in order to resolve collisions between the two objects.

At step 1004, the processor determines that some contact points for the hull mesh collision would be placed on an edge of the first primitive (i.e., edge contact points). The edge may be a concave edge or a flat edge of the mesh object.

At step 1006, the processor generates an edge clip for the edge.

At step 1008, the processor determines, for the edge clip, to face walk into a second primitive of the mesh object across the edge.

At step 1010, the processor generates a set of initial contact points for the hull object colliding with the second primitive of the mesh object using the feature intersection algorithm.

At step 1012, the processor generates a second set of contact points based on projecting each initial contact point in the set of initial contact points in a direction of the contact point normal for the contact points in the first set of contact points onto a plane created by extending the feature of the first primitive.

At step 1014, the processor outputs contact points in the first set of contact points and the second set of contact points as the contact points for the hull object colliding with the mesh object.

An edge clip may be generated in response to determining the edge or the face of the hull object intersects with the flat edge or the concave edge of the second primitive of the mesh object. In some embodiments, a face walk may be performed into a third primitive of the mesh object based at least in part on the presence of another primitive on the other side of the flat edge or the concave edge of the mesh object. Although the above description includes a third primitive, the embodiments disclosed herein are not limited to performing a face walk only between three primitives and that instead the disclosed embodiments describe features for face walking into as many primitives are needed or required. In an embodiment, a determination may be made that an end of the third primitive has been reached, and that the second primitive has been processed in response to extracting features from the edge clip between the second primitive and the third primitive. The method may cease to face walk toward the second primitive in response to the second primitive having already been processed.

In an embodiment, a feature from the second primitive may be extracted and a second set of contact points for the hull object intersecting with the second primitive of the mesh object may be generated using a feature intersection algorithm and the feature. The edge clip may be generated further in response to determining that the edge, the face, or vertex of the hull object is within a region, such as a Voronoi region, of the concave edge of the mesh object. The edge clip may further be generated in response to determining that the edge, the face, or the vertex of the hull object is within the region of the concave edge of the mesh object and outside the bounds of a face of the mesh object.

In one embodiment, primitive vertices of the mesh object may be obtained in response to determining that a face of the mesh object is a promoted feature. Determining to face walk into the second primitive of the mesh object for the edge clip may be determined based at least in part on determining a presence of a valid primitive pair colliding with the hull object in the second primitive of the mesh object. In some embodiments, determining to face walk into the second primitive of the mesh object for the edge clip may be determined based at least in part on determining that the second primitive of the mesh object has not previously been visited and/or based on a determination that the face walking into the second primitive forms an angle less than 90° with respect to the first primitive. In some embodiments, the edge clip may be stored in a data structure that include an identifier for the mesh object intersected by the hull object.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user’s privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for determining contact points for collision between a convex hull and a mesh, the method comprising:
generating a first set of contact points for a hull object colliding with a first primitive of a mesh object using a feature intersection algorithm, wherein a contact normal for the contact points in the first set of contact points is a direction along which contact points on the hull object and the mesh object are constrained by in order to resolve a collision between the hull object and the mesh object;
determining a set of edge contact points for the hull object colliding with the first primitive of the mesh object using the feature intersection algorithm, wherein the set of edge contact points includes contact points along an edge of the first primitive, wherein the edge is a concave edge or a flat edge of the mesh object;
generating an edge clip for the edge;
determining, for the edge clip, to face walk into a second primitive of the mesh object across the edge;
generating a set of initial contact points for the hull object colliding with the second primitive of the mesh object using the feature intersection algorithm;
generating a second set of contact points based on projecting each initial contact point in the set of initial contact points in a direction of the contact normal for the contact points in the first set of contact points onto a plane created by extending the feature of the first primitive on which the contact points in the first set of contact points are located; and
outputting contact points in the first set of contact points and the second set of contact points as output contact points for the hull object colliding with the mesh object, wherein the output contact points for the hull object colliding with the mesh object do not include the set of edge contact points.

2. The method of claim 1, further comprising:
determining, for the edge clip, to face walk into a third primitive of the mesh object based at least in part on determining that the hull object intersects with an edge of the second primitive, wherein the edge of the second primitive is a concave edge or a flat edge of the mesh object.

3. The method of claim 1, wherein generating the edge clip is further in response to determining that an edge, a face, or a vertex of the hull object is within a region of the edge of the first primitive.

4. The method of claim 3, wherein generating the edge clip is further in response to determining that the edge, the face, or the vertex of the hull object is within the region of the edge of the first primitive and outside bounds of the first primitive.

5. The method of claim 1, further comprising extracting a feature from the second primitive, wherein generating the second set of contact points for the hull object is further based on the feature from the second primitive.

6. The method of claim 1, further comprising obtaining primitive vertices of the mesh object in response to determining that the first primitive of the mesh object is a promoted feature.

7. The method of claim 1, wherein determining, for the edge clip, to face walk into the second primitive of the mesh object is further based at least in part on determining a presence of a valid primitive pair colliding with the hull object in the second primitive of the mesh object.

8. The method of claim 1, wherein determining, for the edge clip, to face walk into the second primitive of the mesh object is further based at least in part on determining that the second primitive of the mesh object has not previously been visited.

9. The method of claim 1, wherein determining, for the edge clip, to face walk into the second primitive of the mesh object is further based at least in part on determining that a face of the second primitives face forms an angle less than 90° with respect to a face of the first primitive.

10. The method of claim 1, wherein the edge clip is stored in a data structure that includes an identifier for the mesh object intersected by the hull object.

11. A non-transitory computer-readable storage medium storing instructions that, when executed by one or more processors, cause a computing device to determine contact points for collision between a convex hull and a mesh, by performing operations comprising:
generating a first set of contact points for a hull object colliding with a first primitive of a mesh object using a feature intersection algorithm, wherein a contact normal for the contact points in the first set of contact points is a direction along which contact points on the hull object and the mesh object are constrained by in order to resolve a collision between the hull object and the mesh object;
determining a set of edge contact points for the hull object colliding with the first primitive of the mesh object using the feature intersection algorithm, wherein the set of edge contact points includes contact points along an edge of the first primitive, wherein the edge is a concave edge or a flat edge of the mesh object;
generating an edge clip for the edge;
determining, for the edge clip, to face walk into a second primitive of the mesh object across the edge;
generating a set of initial contact points for the hull object colliding with the second primitive of the mesh object using the feature intersection algorithm;
generating a second set of contact points based on projecting each initial contact point in the set of initial contact points in a direction of the contact normal for the contact points in the first set of contact points onto a plane created by extending the feature of the first primitive on which the contact points in the first set of contact points are located; and
outputting contact points in the first set of contact points and the second set of contact points as output contact points for the hull object colliding with the mesh object, wherein the output contact points for the hull object colliding with the mesh object do not include the set of edge contact points.

12. The computer-readable storage medium of claim 11, wherein generating the edge clip is further in response to determining that an edge, a face, or a vertex of the hull object is within a region of the edge of the first primitive.

13. The computer-readable storage medium of claim 12, wherein generating the edge clip is further in response to determining that the edge, the face, or the vertex of the hull object is within the region of the edge of the first primitive and outside bounds of the first primitive.

14. The computer-readable storage medium of claim 11, further comprising obtaining primitive vertices of the mesh object in response to determining that the first primitive of the mesh object is a promoted feature.

15. The computer-readable storage medium of claim 11, wherein determining, for the edge clip, to face walk into the second primitive of the mesh object is further based at least in part on determining a presence of a valid primitive pair colliding with the hull object in the second primitive of the mesh object.

16. The computer-readable storage medium of claim 11, wherein determining, for the edge clip, to face walk into the second primitive of the mesh object is further based at least in part on determining that the second primitive of the mesh object has not previously been visited.

17. The computer-readable storage medium of claim 11, wherein determining, for the edge clip, to face walk into the second primitive of the mesh object is further based at least in part on determining that a face of the second primitive forms an angle less than 90° with respect to a face of the first primitive.

18. A device for determining contact points for collision between a convex hull and a mesh, the device comprising:
a memory storing instructions; and
one or more processors configured to execute the instructions to cause the device to:
generate a first set of contact points for a hull object colliding with a first primitive of a mesh object using a feature intersection algorithm, wherein a contact normal for the contact points in the first set of contact points is a direction along which contact points on the hull object and the mesh object are constrained by in order to resolve a collision between the hull object and the mesh object;
determine a set of edge contact points for the hull object colliding with the first primitive of the mesh object using the feature intersection algorithm, wherein the set of edge contact points includes contact points along an edge of the first primitive, wherein the edge is a concave edge or a flat edge of the mesh object;
generate an edge clip for the edge;
determine, for the edge clip, to face walk into a second primitive of the mesh object across the edge;
generate a set of initial contact points for the hull object colliding with the second primitive of the mesh object using the feature intersection algorithm;
generate a second set of contact points based on projecting each initial contact point in the set of initial contact points in a direction of the contact normal for the contact points in the first set of contact points onto a plane created by extending the feature of the first primitive on which the contact points in the first set of contact points are located; and
output contact points in the first set of contact points and the second set of contact points as output contact points for the hull object colliding with the mesh object, wherein the output contact points for the hull object colliding with the mesh object do not include the set of edge contact points.

19. The device of claim 18, wherein generating the edge clip is further in response to determining that an edge, a face, or a vertex of the hull object is within a region of the edge of the first primitive.

20. The device of claim 19, wherein generating the edge clip is further in response to determining that the edge, the face, or the vertex of the hull object is within the region of the edge of the first primitive and outside bounds of the first primitive.
